(19) United States
(12) Patent Application Publication
(10) Pub. No.: US 2026/0213845 A1
(43) Pub. Date: Jul. 23, 2026

(54) CO-PACKAGING WITH HIGH FREQUENCY LINKS

(71) Applicant: Mellanox Technologies, Ltd., Yokneam (IL)

(72) Inventors: Elad Mentovich, Tel Aviv (IL); Juan Jose Vegas Olmos, Solroed Strand (DK)

(73) Assignee: Mellanox Technologies, Ltd., Yokneam (IL)

(21) Appl. No.: 19/035,428

(22) Filed: Jan. 23, 2025

(51) Int. Cl. H04B 10/40; H04Q 11/00

(52) U.S. Cl. CPC H04B 10/40; H04Q 11/0005; H04Q 11/0062; H04Q 2011/0069

(57) ABSTRACT

Circuit packages that include an optical switch having a wireless interface and multiple floating transceivers disposed along a periphery of the optical switch. At lease some of the floating transceivers are configurable to map a number M of optical channels from an optical fiber into a number N of wireless bands in a terahertz spectrum, wherein M≠N in some cases.

### BACKGROUND

In the field of computer hardware, a circuit package (henceforth also, just ‘package’) typically refers to an encapsulated assembly comprising multiple devices, which may include integrated circuits (ICs), passive components, and other elements. The package provides a shared housing, physical protection, and signaling connections to and between its components, among other things.

A package may comprise multiple chips, the silicon die on which a circuit or other device is fabricated. The package comprises the larger, protective enclosure for the die that facilitates their integration into a larger system, e.g., a motherboard.

Optical co-packaging refers to the integration of multiple optical components or devices of a circuit within a single package. Optical co-packaging enables compactness, efficiency, and improved performance in optical systems. By combining different optical elements such as lasers, photodetectors, waveguides, switches, and passive optical components into a single package, optical co-packaging may streamline manufacturing processes, reduce costs, and enhance system integration.

Optical co-packaging addresses the demand for high-speed and high-bandwidth optical communication systems. This demand arises from emerging applications in areas such as data centers, telecommunications, and sensing technologies. By integrating various optical components into the same package, optical co-packaging may enable reduced signal losses, improved signal integrity, and enhanced thermal management.

Optical co-packaging may be implemented using various mechanisms, including wafer-level integration, flip-chip bonding, and hybrid integration. These techniques enable the alignment and connection of optical components within a compact package, while also facilitating efficient heat dissipation and reliable signaling interconnections.

The co-packaging of optical switches that utilize lasers or hard-wired links between a central switch and peripheral transceivers may lead to die layouts that increase rapidly in area as the port count and/or capacity per port of the switch increases.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an exemplary server system in accordance with one embodiment.

FIG. 2 depicts a network interface card in accordance with one embodiment.

FIG. 3 depicts an example of a system including multiple network interface cards.

FIG. 4 depicts an exemplary processing system in accordance with another embodiment.

FIG. 5 depicts an exemplary computer system in accordance with one embodiment.

FIG. 6 depicts a central die of a package comprising an optical switch with a number of floating transceiver die disposed around its periphery.

FIG. 7 depicts a networking device in accordance with one embodiment.

FIG. 8 depicts an exemplary co-packaging arrangement wherein one or more transceivers are configured to receive an optical fiber that is non-colinear with a wireless channel between the transceiver and the optical switch.

FIG. 9 and FIG. 10 depict additional aspects of a transceiver and an optical switch in one embodiment.

FIG. 11 depicts an exemplary data center 1100 in accordance with at least one embodiment.

### DETAILED DESCRIPTION

In conventional packages comprising both optical and electronic circuits, interconnection between transceivers and certain optical components, e.g., optical switch, may utilize optical fibers. This may involve expensive connectivity solutions. The lasers utilized in these interfaces may draw substantial amounts of power. The physical space needed for fiber-based connections may constrain the scalability of these solutions. Stringent alignment requirements for fiber-based connections may constrain layout flexibility.

In co-packaging implementations that comprise a switch, one challenge is how to implement effectively the high-speed interconnect between the central switch tile and floating tiles. The use of fiber for these interconnections may increase the area of the tiles, may increase the cost or complexity of manufacturing the package due to strict constraints on tile placement relative to the central switching tile, and may complicate adjacent tile replacement in case of damage.

Disclosed herein are embodiments of co-packaged optical switch devices wherein the package includes a central die comprising the optical switch, floating die comprising optical transceivers, wireless interconnects between the switching die and the floating transceiver die, and an optical fiber interconnect to interface the floating die with a more extensive external circuit/network structure. Layout flexibility and port scalability may be enabled by way of wireless channels interfacing the central die to the floating die.

The transceivers and the central switch may utilize a terahertz-range wireless interconnect providing an effective bandwidth on par with optical fiber interconnects. In conventional systems the use of optical fiber interconnects between the transceivers and the central switch may increase the size, cost, and complexity of the package overall, and make scaling to higher number of ports a challenge. A terahertz-range wireless interconnect enables a more flexible coupling solution.

The disclosed mechanisms address these limitations of conventional approaches, and may facilitate replacement or reconfiguration of adjacent tiles such as faulty or poorly-performing transceivers if needed as they are floating and not fiber connected. The disclosed mechanisms may also facilitate alignment when putting together all the tiles and layout of the transceiver die in the package with the central switching die, and may reduce the utilization of opto-electronic converters in the package, saving power consumption.

Terahertz-range communication may utilize highly directional antennae, reducing the likelihood of crosstalk between wireless channels. The available spectrum for short-range (e.g., centimeter-scale) terahertz communication may be more than adequate to provide sufficient channel separation that avoids crosstalk. Additionally, pre-calibration of the transceivers in the package may be performed to identify a combination of wireless channels for each that provides a lowest bit error rate (BER).

Power and circuit area savings may arise from the use of terahertz-range wireless signaling over distances in a range of a few centimeters, such as between adjacent data processing units on a same plane in a data center rack, or between data processing units on vertically-adjacent racks.

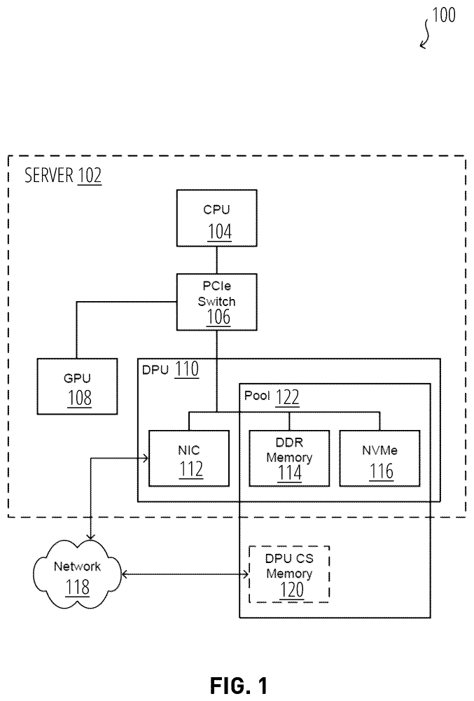

FIG. 1 depicts an example computing environment 100 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures.

The example computing environment 100 may include a server 102 which may be used to perform HPC workloads, such as AI training or machine learning model training. In an embodiment, the server 102 may be an application instance or a compute node. The server 102 may include a CPU 104 associated with a switch 106, such as a peripheral component interconnect express (PCIe) switch, which may control at least some data transmission over communication paths interconnecting various components. In an embodiment, the CPU 104 may include a root complex processor.

The PCIe switch 106 may also be associated with a GPU 108 and a DPU 110, and may transmit data between at least some of the CPU 104, the GPU 108, the DPU 110, and other components. In an embodiment, the PCIe switch 106 may be associated with more than one GPU or more than one DPU. In another embodiment, the PCIe switch 106 may be located within the DPU 110. The PCIe switch 106 may manage the transfer of at least some data between the CPU 104, the GPU 108, and the DPU 110. In another embodiment, the number of GPUs associated with the PCIe switch 106 may be equal to the number of DPUs associated with the PCIe switch 106. In at least one embodiment, the server 102 may include, without limitation, any number of the CPUs 104, the PCIe switches 106, the GPUs 108, and/or the DPUs 110, in any combination. For example, in at least one embodiment, server 102 could include eight, sixteen, thirty-two, and/or more GPUs 108.

Due to high bandwidth requirements, the switch 106 may be an optical switch implemented on a central die, co-packaged with a plurality of transceiver die arranged around the periphery of the switch die.

In at least one embodiment, communication paths interconnecting various components, including but not limited to the CPU 104, the PCIe switch 106, the GPU 108, and the DPU 110, in FIG. 1 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 110 may include a network interface card (NIC) 112, a DDR memory 114, and a non-volatile memory express (NVMe) device 116. The NIC 112 may be able to interface with a network 118, which may also interface with additional NVMe devices available to the DPU 110, such as over fabric. In an embodiment, the DPU 110 may not include the NVMe device 116. In another embodiment, the NVMe device 116 may be located on the server 102 and not on the DPU 110.

The NIC 112 and the DPU 110 may serve different roles in network architecture, despite both facilitating network connectivity. A NIC may primarily provide a hardware interface to connect elements of a computing system to a network. A NIC may handles basic network communication tasks such as formatting, sending, and receiving data packets. The processing capabilities of a NIC may be limited to traditional network processing tasks.

A DPU is a specialized processing unit designed to offload and accelerate complex data processing tasks from the NIC or computing system. A NIC may combine a network interface, programmable processing, and storage capabilities and may perform tasks such as security, storage virtualization, and network telemetry.

In yet another embodiment, the computing environment 100 may include more than one of the NVMe device 116, such as a first NVMe device in the DPU 110 and a second NVMe device on the server 102 associated directly with the PCIe switch 106. In an embodiment, the DPU 114 may not include the DDR memory 114 and may include a computational storage services (CSS) in place of, or in addition to, the DDR memory 114. For example, computing environment 100 may include DPU computational storage (CS) memory 120 available to the DPU 110 as part of the CSS. The network 118 may be able to interface with the DPU CS memory 120 through the NIC 112, according to any suitable interface protocol, such as remote direct memory access (RDMA) over Ethernet, InfiniBand, Fiber Channel, etc.

The total memory of the computing environment 100 available for data storage may be expanded through the use of the DPU 110 on nodes of the system. The DPU 110 may have access to a pool 122 of memory already available to the server 102, such as double data rate (DDR) memory, on-board NVMe devices, NVMe devices over fabric, and CS. The pool 122 of memory may include at least one of the DDR memory 114, NVMe device 116, and the DPU CS memory 120.

The DPU 110 may also be able to access the available memory of other DPUs as part of the pool 122, and other DPUs may be able to access the available memory of DPU 110, such as the pool 122. This available memory can be accessed and utilized for data storage, without the addition of compute resources, such as compute nodes, which would be required using other solutions.

The available pool 122 accessible to the DPU 110 may be provisioned for the server 102 to expand the total memory available for data storage, such as to reduce the data storage load on the CPU 104 or the GPU 108, which can instead increase the utilization of their memory for processing. For example, during training of an AI, the model states, residual states, activation functions, and checkpoints can be stored, or offloaded, on the pool 122 accessible to the DPU 110.

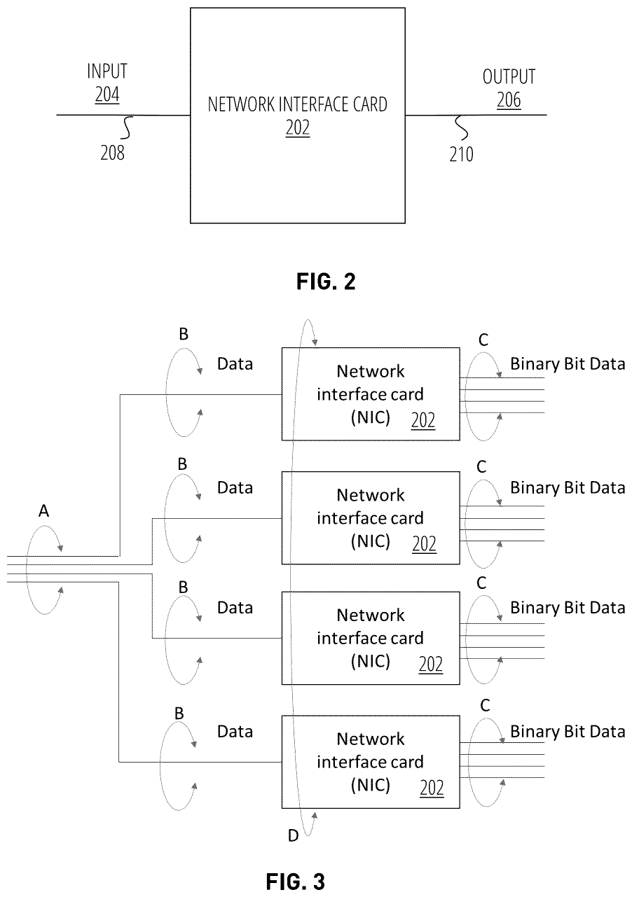

FIG. 2 depicts a network interface card 202 that may comprise a hardware component (e.g., a network interface controller) configured to connect to a network and/or to facilitate communications within the network. In certain embodiments, the network interface card 202 may be included in and/or may be coupled to a network interface module such as a transceiver device (e.g., an optical transceiver) that facilitates fiber optic communication. In one or more embodiments, the network interface card 202 may be configured to manage transmission of one or more optical signals via one or more optical fibers. Additionally or alternatively, in one or more embodiments, the network interface card 202 may be configured to control emission of one or more optical signals via one or more lasers.

The network interface card 202 may comprise an input 204 and an output 206 coupled to a communication channel 208 and a communication channel 210. Due to high bandwidth requirements, the network interface card 202 may comprise an optical switch implemented on a central die, co-packaged with a plurality of transceiver die arranged around the periphery of the switch die. A network interface card 202 such as the one depicted may utilize a co-packaged die arrangement in accordance with the embodiments described herein.

The communication channel 208 may for example comprise an optical communication channel (e.g., a transparent fiber optical connection) that transmits data (e.g., pulses of infrared light) encoded as bits (e.g., a binary data stream). The network interface card 202 may be configured to output bits via the communication channel 210. The communication channel 208 and/or the communication channel 210 may in some embodiments be bi-directional.

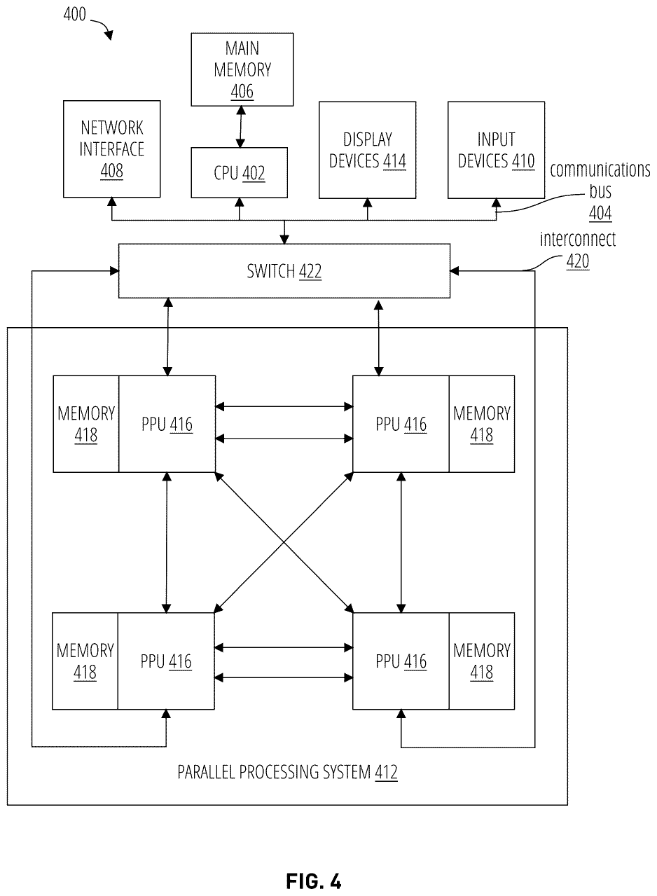

FIG. 3 depicts an example of a system including multiple network interface cards. Each of the network interface cards 202 may be configured in one of the manners described above. A plurality of inputs A comprising data signals B may be input to a number D of network interface cards 202 and routed out of the network interface cards 202 as binary bit data C. Signals A, B, and C may be optical (photonic), electronic, or a mixture of optical and electronic.

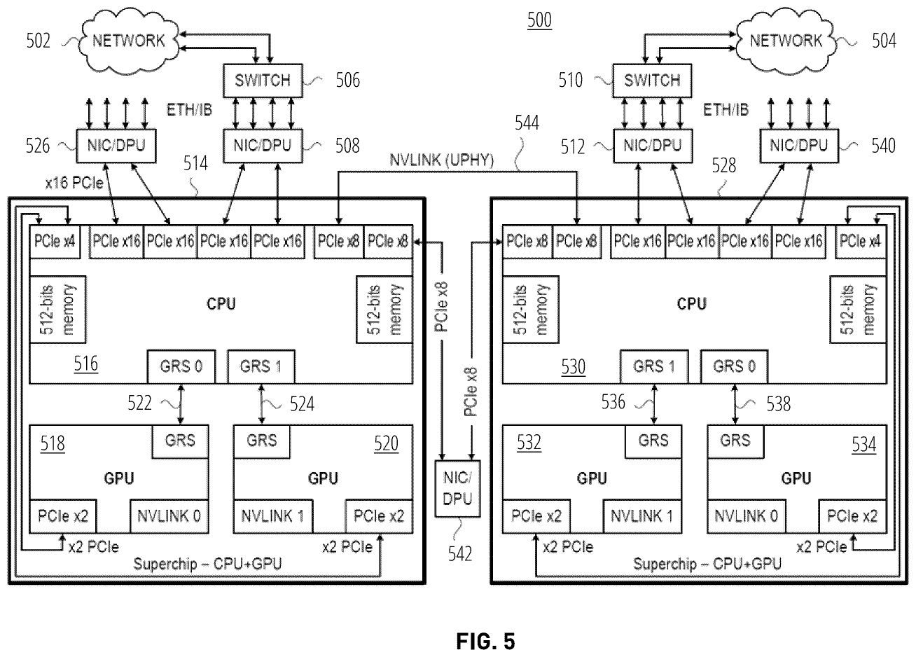

FIG. 4 depicts a computer system 400, according to at least one embodiment. In at least one embodiment, computer system 400 is configured to implement various processes and methods described throughout this disclosure.

In at least one embodiment, computer system 400 comprises, without limitation, at least one central processing unit (“CPU”) 402 that is connected to a communication communications bus 404 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 400 includes, without limitation, a main memory 406 and control logic (e.g., implemented as hardware, software, or a combination thereof) and data are stored in main memory 406 which may take form of random-access memory (“RAM”). In at least one embodiment, a network interface subsystem (“network interface”) 408 provides an interface to other computing devices and networks for receiving data from and transmitting data to other systems from computer system 400.

In at least one embodiment, computer system 400 includes, without limitation, input devices 410, parallel processing system 412, and display devices 414 which can be implemented using a conventional cathode ray tube (“CRT”), liquid crystal display (“LCD”), light emitting diode (“LED”), plasma display, or other suitable display technologies. In at least one embodiment, user input is received from input devices 410 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 406 and/or secondary storage. Computer programs, if executed by one or more processors, enable computer system 400 to perform various functions in accordance with at least one embodiment. Main memory 406, secondary storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 402; parallel processing system 412; an integrated circuit capable of at least a portion of capabilities of both CPU 402; parallel processing system 412; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 400 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 412 includes, without limitation, a plurality of parallel processing units (“PPUs”) 416 and associated memories 418. In at least one embodiment, PPUs 416 are connected to a host processor or other peripheral devices via an interconnect 420 and a switch 422 or multiplexer.

In some embodiments, the switch 422 may be an optical switch implemented on a central die, co-packaged with a plurality of transceiver die arranged around the periphery of the switch die. A switch 422 such as the one depicted may utilize a co-packaged die arrangement in accordance with the embodiments described herein.

In at least one embodiment, parallel processing system 412 distributes computational tasks across PPUs 416 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 416, although such shared memory may incur performance penalties relative to use of local memory and registers resident to a PPU 416. In at least one embodiment, operation of PPUs 416 is synchronized through use of a command such as_syncthreads ( ), wherein all threads in a block (e.g., executed across multiple PPUs 416 to reach a certain point of execution of code before proceeding.

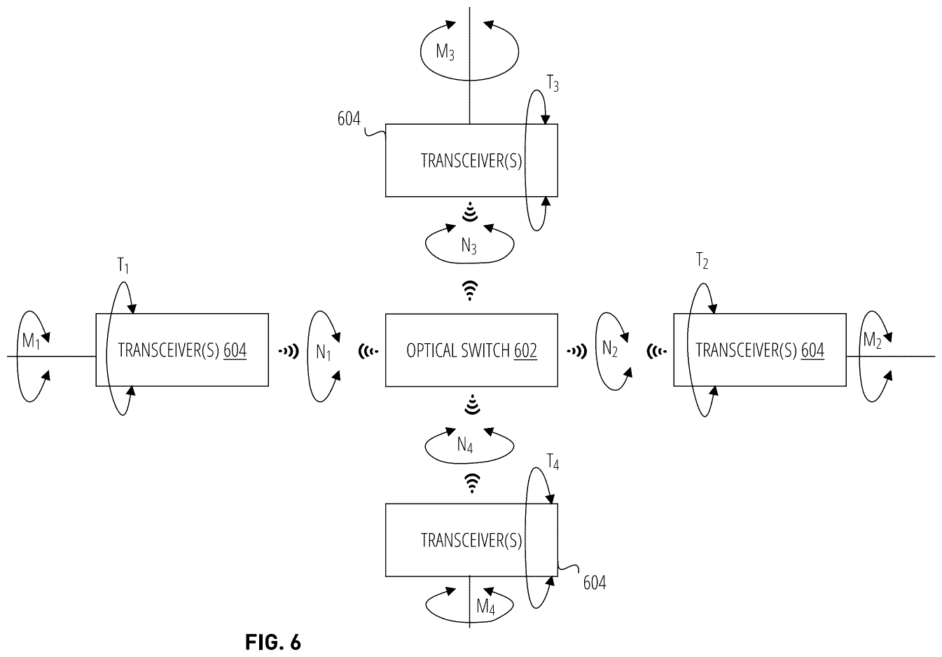

FIG. 5 depicts a block diagram that schematically illustrates a computing system 500, e.g., a data center or a High-Performance Computing (HPC) cluster, in accordance with an embodiment that is described herein. The computing system 500 comprises a plurality of subsystems, e.g. multiple processing devices coupled to each other, multiple network devices, and multiple networks, according to at least one embodiment. Computing system 500 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU (Data Processing Unit) to ensure efficient data transfer across computing system 500 and to one or more external networks 502, 504. In the present example, system 500 comprises a packet switch 506 that connects NIC/DPU 508 to network 502, and a packet switch 510 that connects NIC/DPU 512 to network 504.

One or more of the NICs, DPUs, and switches depicted depicted may utilize a co-packaged die arrangement in accordance with the embodiments described herein.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 500 can include one or more CPUs and one or more GPUs.

FIG. 5 also depicts an example of a multi-GPU architecture. As depicted, computing system 500 includes a processing device 514 with a multi-GPU architecture. In particular, processing device 514 may be a system-on-chip that includes multiple subsystems such as a CPU 516, a GPU 518, and a GPU 520. CPU 516 can be coupled to GPU 518 via a die-to-die (D2D) or chip-to-chip (C2C) interconnect 522, such as a Ground-Referenced Signaling interconnect (GRS interconnect). CPU 516 can be coupled to GPU 520 via a D2D or C2C interconnect 524. CPU 516 can also couple to GPU 518 and GPU 520 via PCIe interconnects.

CPU 516 can be coupled to one or more NICs or DPUs, which are coupled to one or more networks. For example, as depicted in FIG. 5, CPU 516 is coupled to a first NIC/DPU 526, which is coupled to a network 502. CPU 516 is also coupled to a second NIC/DPU 508, which is coupled to network 502 via switch 506. NIC/DPU 526 and NIC/DPU 508 can be coupled to network 502 over Ethernet (ETH), NVLINK or InfiniBand (IB) connections, for example.

Computing system 500 also includes a processing device 528 with a multi-GPU architecture. In particular, processing device 528 includes multiple subsystems including a CPU 530, a GPU 532, and a GPU 534. CPU 530 can be coupled to GPU 532 via an D2D or C2C interconnect 536. CPU 530 can be coupled to GPU 534 via a D2D or C2C interconnect 538. CPU 530 can also couple to GPU 532 and GPU 534 via PCIe interconnects. CPU 530 can be coupled to one or more NICs or DPUs, which are coupled to one or more networks. For example, as illustrated in FIG. 5, CPU 530 is coupled to a first NIC/DPU 512, which is coupled to a network 504. CPU 530 is also coupled to a second NIC/DPU 540, which is coupled to network 504 via switch 510. NIC/DPU 512 and NIC/DPU 540 can be coupled to network 504 over Ethernet (ETH), NVLINK or InfiniBand (IB) connections.

In at least one embodiment, processing device 514 and processing device 528 may communicate with each other via a NIC/DPU 542, such as over PCIe interconnects. Processing device 514 and processing device 528 may also communicate with each other over a high-bandwidth communication interconnects 544, such as an NVLink interconnect or other high-speed interconnects. The packet switches in FIG. 5 may comprise, for example, Nvidia Quantum-2 switches. The NICs/DPUs in the figure may comprise, for example, Nvidia Bluefield DPUs.

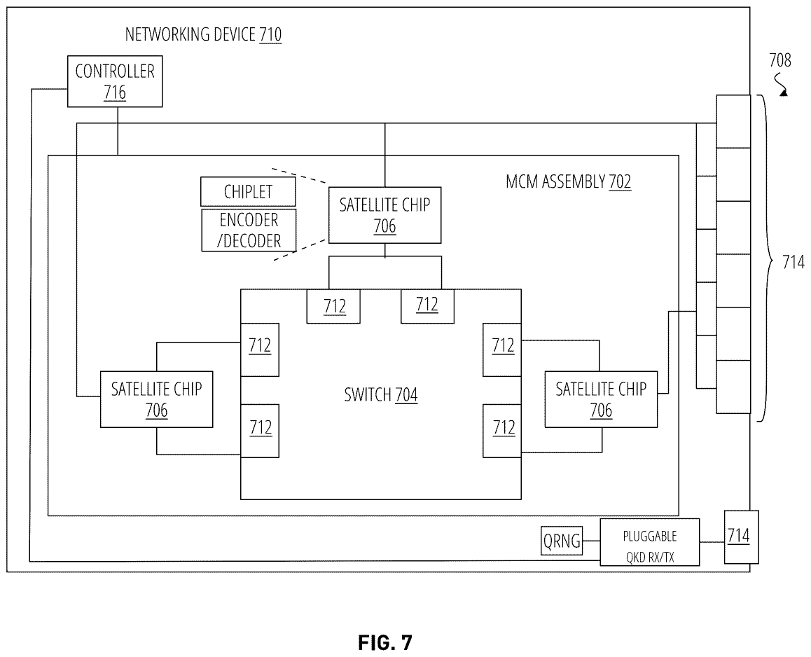

Referring to FIG. 6, a central die of a package may comprise an optical switch 602 (e.g., a central die comprising the optical switch 602) with a number of floating transceivers 604 disposed around its periphery. In general, one or all of the transceivers 604 may each be implemented using N>=1 physical die. The figure shows the connection of the transceiver with the optical switch for a single channel.

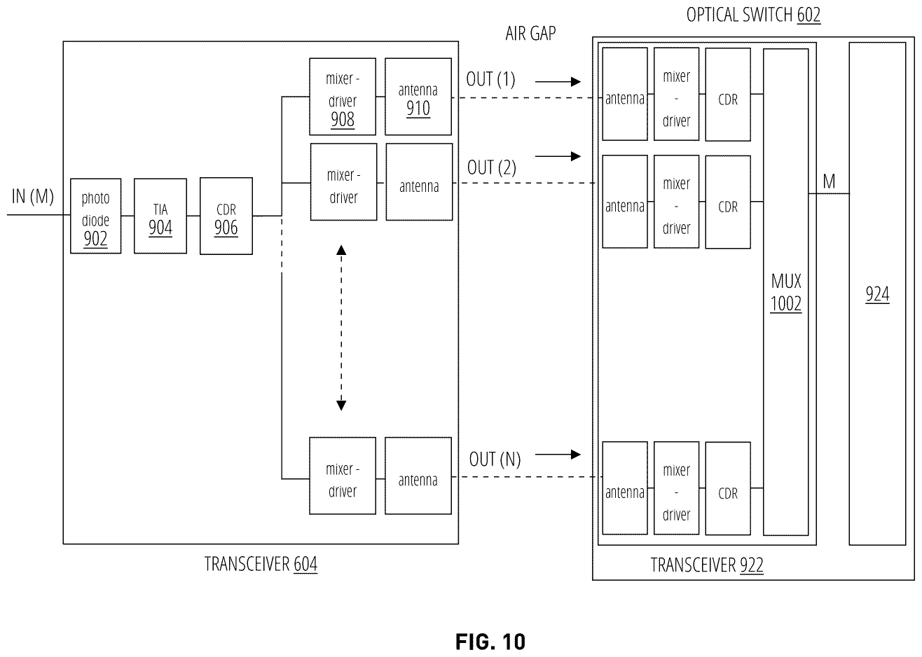

As depicted in the embodiment of FIG. 9, each transceiver 604 may comprise an arrangement of elements that transform light signals to and from wireless signals. The transceiver chain comprises several building blocks enabling the transition from a fiber based channel (i.e. on light) to a wireless channel (i.e. on air): no fiber connections between the main tile and the adjacent optical tiles. The package may for example be implemented as a multi-die integrated circuit that interfaces to a Network Interface Card (NIC) or Data Processing Unit (DPU), and/or in a NIC or DPU itself.

A tile may comprise an individual die or one or more dies, where individual dies may be communicatively coupled using an interconnect mechanism (e.g., embedded multi-die interconnect bridge (EMIB)). Non-limiting examples of tiles that may be co-packaged include memory tiles (e.g., High Bandwidth Memory-HMB), substrate tiles, base tiles, link tiles, and EMIB tiles. One embodiment of a co-packaging arrangement may include a compute tile comprising a number (e.g., 8) of graphics cores, an L1 cache, a base tile with a PCI (e.g., PCIe 5) host interface, memory tiles (e.g., HBM2e), a Multiple Data Flow Interface tile (MDFI), an EMIB tile, and a link tile comprising multiple links and ports (e.g., 8 links and 8 ports with an embedded switch).

In at least one embodiment, the tiles of the package may be connected use face-to-face (F2F) chip-on-chip bonding through fine-pitched micro-bumps (e.g., copper pillars). In at least one embodiment, the package may include a graphics core that comprises a memory fabric and memory tiles communicatively coupled to multiple other tiles. The graphics core in such embodiments may store, access, and/or load hardware contexts in the memory, where a hardware context is a set of data loaded from registers, and where a hardware context may define a state of the components in the package (e.g., the state of a graphics processing unit).

The optical switch 602 may comprise an optical switching fabric configured to ingest data packets at various source/input ports and route the packets to various output/destination ports. In some embodiments, the optical switch 602 may comprise internal components operating at different speeds. Each of the input ports and output ports of the optical switch 602 may comprise N≥1 wireless communication channels. The wireless communication channels may for example be terahertz or millimeter wave, operating at bandwidths ranging from 20GHz to 10 terahertz.

A number Tₓ of transceiver die may be disposed along a given side of the optical switch 602, where Tₓ may vary by side. Each of the transceiver die may be configured to communicate with the optical switch 602 over the Nₓ wireless channels, where Nₓ may be configurable for each transceiver 604 or for some subset of the transceivers 604. Each transceiver 604 may be configured with a number Mₓ≥1 optical fiber-based input channels and Mₓ fiber-based output channels, where again Mₓ may be configurable for each transceiver 604. The Mₓ optical channels may be supplied to a given transceiver 604 be a single fiber or multiple fibers. In embodiments where Mₓ≠Nₓ, one or more of the transceivers 604 may operate as channel multiplexers, demultiplexers, or combinations thereof.

Optical switches are one solution for enabling advances in networking due to the technology's potential for very high data capacity and low power consumption. Optical switches feature optical input and output ports and are capable of routing light that is coupled to the input ports to the intended output ports on demand, according to one or more control signals (electrical or optical control signals). Routing of the signals is performed in the optical domain, i.e. without the need for optical-electrical and electrical-optical conversion, thus bypassing the need for power-consuming transceivers. Header processing and buffering of the data is not possible in the optical domain and thus, packet switching (as it is realized in electrical switches) cannot be employed. Instead, the circuit switching paradigm is used: an end-to-end circuit is created for the communication between two endpoints connected on the input and the output of the optical switch. Director switches may be used in common datacenter interconnection topologies, e.g., fat trees, Slim Fly, and Dragonfly+). In addition, inventive concepts propose to place such hybrid switching systems “in the middle” of the network (e.g., replacing the edge/top of rack (TOR) layer and aggregation layer).

An optical switch may include hardware and/or software for routing signals in the optical domain. Thus, in one embodiment, an optical switch may include input optical fibers and output optical fibers that carry optical signals as well as one or more devices suited for routing optical signals within the optical switch. For example, the one or more devices for routing optical signals may include one or more movable mirrors (e.g., MEMS mirrors) that are controlled to move in a manner that directs light from an input fiber to a desired output fiber or to move in a manner that forces or guides light from one waveguide into another waveguide. An optical switch may include one or more devices for amplifying light in order to compensate for propagation and scattering losses introduced by the optical switch. In at least one example embodiment, signals input and output to an Application Specific Integrated Circuit (ASIC) are optical, meaning that each optical switch connected to an electrical switch routes optical signals received from the electrical switch without using hardware and/or software that converts an electrical signal into an optical signal for routing within the optical switch. However, example embodiments are not limited thereto, and an optical switch may include electrical to optical to electrical conversion hardware and/or software if desired (e.g., if the input signal and/or output signal is an electrical signal).

The optical switch(es) may include an arrayed waveguide grating router (AWGR), which is a passive switch fabric. In some embodiments, the optical switch(es) may correspond to a passive element that operates as a wavelength router that uses multiple wavelengths to interconnect outputs and inputs by following a specific cyclic wavelength routing pattern.

An optical switch, on the other hand, may function by directly routing optical signals without converting them to electrical signals. Each optical switch may include optical receivers, such as photodetectors and wavelength-division multiplexing (WDM) demultiplexers, that receive incoming optical signals. These optical signals may then be directed through internal optical switching components, such as micro-electromechanical systems (MEMS) mirrors, waveguides, or optical cross-connects, which route the signals to the appropriate output paths. The optical switch may also include optical transmitters, such as laser diodes and modulators, which transmit the routed optical signals to the next switch in the network. A hybrid electro-optical switch may combine both electrical and optical components to route signals. Such a switch may include receivers that convert optical signals into electrical signals using TIAs and photodetectors, similar to those in electrical switches. These electrical signals can then be routed within the switch using internal electrical switching circuitry. Additionally, the hybrid switch may contain optical switching components, such as WDM multiplexers and MEMS devices, to route optical signals directly. The transmitters in a hybrid switch may include both electrical-to-optical converters and direct optical transmitters, enabling the hybrid switch to interface with both electrical and optical networks. For example, a hybrid switch's transmitter may include a light source, a modulator for optical signals, and traditional electrical signal transmitters, providing routing capabilities across different signal domains.

The interconnections between the switches within the network topology may be implemented via optical fibers or traditional electrical cables, depending on the specific requirements of the system. For instance, the communication lanes may be constructed of dedicated differential cable pairs and/or fiber optics, each tailored to provide optimal performance for the data transmission needs. The dedicated differential cable pairs used in these interconnections may include a variety of cable media such as copper, aluminum, gold, silver, nickel, or composite materials like copper-clad aluminum, copper-clad steel, or bimetallic conductors. These materials may be chosen for their electrical conductivity and durability, ensuring reliable and efficient data transmission. For example, in a four-lane network, each lane may consist of its own dedicated copper cable, providing isolated physical paths for each communication lane of a deserialized data stream. This configuration helps in maintaining signal integrity and reducing crosstalk between lanes.

Alternatively, fiber optic cables may be employed for the interconnections. Fiber optics are capable of transmitting data streams via different wavelengths of light, with each data stream assigned a unique wavelength. The use of fiber optic cables may allow multiple data streams to be transmitted simultaneously through a single fiber optic cable, significantly increasing the bandwidth and efficiency of the network, and particularly advantageous for long-distance data transmission and for applications requiring high data transfer rates.

Various optical networking technologies can be used to transmit multiple optical signals (e.g., data signals or data streams) over a single optical fiber within an optical link with little to no optical signal interference. These technologies may be used to improve bandwidth efficiency and reduce the amount of infrastructure needed for data communication.

One such technology is Time Division Multiplexing (TDM). In TDM, multiple optical signals can be transmitted over a single optical fiber by assigning each optical signal a respective time slot and transmitting an optical signal during its assigned time slot. The time slots are allocated in a cyclic manner, with each optical signal transmitting a small amount of data during its assigned time slot. The time slots are very short, on the order of microseconds, and the cycle repeats many times per second, allowing for rapid data transfer.

Another technology is Frequency Division Multiplexing (FDM). In FDM, multiple optical signals can be transmitted over a single optical fiber by assigning each optical signal a respective frequency band. Each optical signal is modulated onto a respective carrier frequency to generate a modulated signal, and these modulated signals are combined and transmitted over a single optical fiber. At the receiver, the modulated signals are separated using filters (e.g., band-pass filters) that permit optical signals meeting specific frequency specifications to pass through while filtering out other signals. FDM allows optical links to simultaneously transmit multiple channels over the same frequency band.

Yet another technology is Wavelength Division Multiplexing (WDM). In WDM, multiple optical signals having different wavelengths are combined into a single optical signal and transmitted over a single optical fiber. WDM techniques involve combining and separating multiple optical signals with different wavelengths onto a single optical fiber, allowing for more data to be transmitted and increasing the capacity of the optical fiber.

Examples of WDM technology include Coarse Wavelength Division Multiplexing (CWDM) and Dense Wavelength Division Multiplexing (DWDM). CWDM combines multiple optical signals at different wavelengths into a single optical signal and transmits it over a single optical fiber. CWDM uses a wider wavelength separation, such as about 80 nanometers (nm), which means it supports fewer channels and has lower power budgets, making it suitable for shorter distances, up to about 80 kilometers (km). CWDM requires less complex equipment and lower-cost optical components, making it a cost-effective solution for applications that do not require dense wavelength separation. In contrast, DWDM uses narrower wavelength separation, such as about 0.8 nm, allowing for higher channel capacity and longer distances, but typically at a higher cost and complexity.

In an embodiment, a switch may comprise input circuits and output circuits, linked by switching core. The switch may be in a network, most specifically in a switching fabric, such as an InfiniBand fabric. Thus, the switch may comprise multiple inputs and outputs.

A number of architectures of this type include “Next Generation I/O” (NGIO) and “Future I/O” (FIO), culminating in the “InfiniBand” architecture, which has been advanced by a consortium led by a group of industry leaders (including Intel, Sun, Hewlett Packard, IBM, Compaq, Dell and Microsoft). Storage Area Networks (SAN) provide a similar, packetized, serial approach to high-speed storage access, which can also be implemented using an InfiniBand fabric.

Communications between a parallel bus and a packet network generally require a communications interface, to convert bus cycles into appropriate packets and vice versa. For example, a host channel adapter or target channel adapter can be used to link a parallel bus, such as the PCI bus, to the InfiniBand fabric. When the adapter receives data from a device on the PCI bus, it inserts the data in the payload of an InfiniBand packet, and then adds an appropriate header and error checking code, such as a cyclic redundancy check (CRC) code, as required for network transmission. The InfiniBand packet header includes a routing header and a transport header. The routing header contains information at the data link protocol level, including fields required for routing the packet within and between fabric subnets. The transport header contains higher-level, end-to-end transport protocol information. Similar headers are used in other types of packet networks known in the art, such as Internet Protocol (IP) networks.

In at least one embodiment, a computer system may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

Optical cables and connectors may be designed to comply with any applicable standard, for example Ethernet and InfiniBand standards, such as Ethernet variants 200GBASE-FR4, 400GBASE-FR4, and 100GBASE-LR4 to support four wavelengths.

High-capacity optical switch assemblies switch multiple channels of data at high data rates, with the number of channels reaching several hundreds and data rates reaching hundreds of Gb/s (Gb/s=109 bits per second). In order to save power, it is desirable to co-package the switch itself with “optical engines,” which typically are small, high-density optical transceivers located within an application-specific integrated circuit (ASIC) or within an ASIC package together with the switch.

The switch assembly is contained in a rack-mounted case, with optical receptacles on its front panel for ease of access. The signals from and to the ASIC are conveyed to and from the optical receptacles using optical fibers.

Space constraints of the switch and the front panel limit the number of optical fibers connected to the ASIC and optical receptacles on the panel. Therefore, the optical signals emitted and received by the switch are multiplexed using wavelength-division multiplexing, so that each fiber, along with the associated optical receptacle, carries multiple optical signals. For example, each fiber may carry four channels of 100 Gb/s each, at four different, respective wavelengths, to and from the corresponding optical receptacle, for a total data rate of 400 Gb/s (denoted as 4×100 Gb/s).

In many cases, the multiple communication channels carried at different wavelengths on the same fiber are directed to and from different network nodes. For example, each of the 100 Gb/s component signals on a 4×100 Gb/s optical link may be directed to a different server. Therefore, there is a need for an optical cable that is capable of splitting the multiplexed optical signal into multiple component signals at different, respective wavelengths, and be capable of conveying each of these signals to a different network node. For simplicity of installation and use, it is desirable that the optical cable be “active,” meaning that transceivers in the cable convert each of the multiple optical signals to a standard electrical form (and vice versa). As a result, the network nodes need process only electrical signals and will be indifferent to the actual wavelength of the optical channel that is directed to each of them.

To further simplify installation and use, it is sometimes desirable that the optical cable be detachable from the transceivers so that a smaller cable may be routed through an installation. Each optical cable may, instead of comprising a transceiver, be designed to mate with a particular transceiver. The transceiver may be connected to a node, such as a server, and be used to connect a connector of each cable to the node as described herein.

A CPO package may integrate photonic high-speed optical interconnect components with functional switch application-specific integrated circuits (ASICs) or graphics processing units (GPUs) on a common substrate. By using CPO packages, computing systems may significantly reduce cost and power consumption over current systems. Current methods of manufacturing CPO packages involve optical elements that require active alignment in order to transmit the optical signal properly. In a traditional CPO package, an optical signal is transmitted via optical fibers to a connector that is either fixed (e.g., connected by adhesive) or detachable (e.g., connected by a clip) to a SiP die.

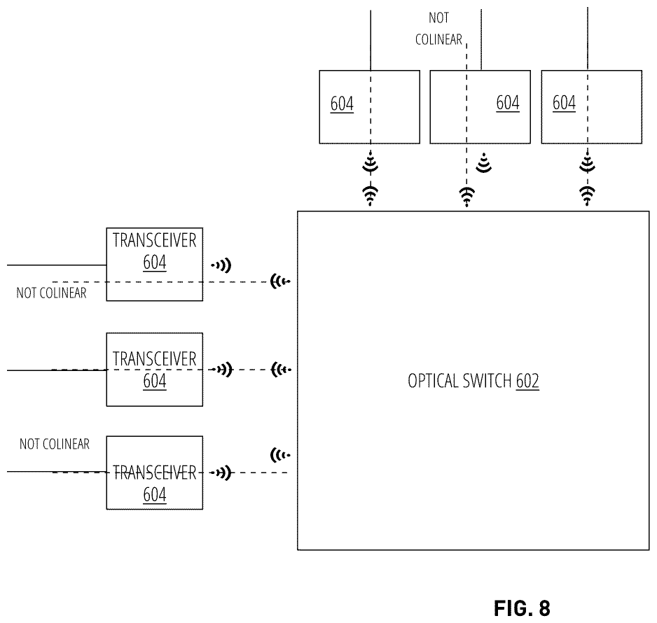

FIG. 7 depicts a co-packaged system in accordance with one embodiment. Co-packaging may refer to the close integration of different electrical and/or optoelectronic chips in the same package. In some embodiments, the different chips that constitute the co-packaged system may be assembled on a single substrate in what is typically called a multi-chip module (MCM) assembly 702. The multi-chip module assembly 702 may include switch 704 surrounded by peripheral chips, which may also be referred to as satellite chips 706 or chiplets. In some embodiments, the switch 704 and satellite chips 706 may all be mounted on a common substrate, although such a configuration may not be required. The various components of the multi-chip module assembly 702 may be coordinated and controlled by way of a central controller 716.

The multi-chip module assembly 702 may be disposed proximate to a front panel 708 of a housing of a networking device 710 (e.g., the network device(s) of a data center). In some embodiments, the switch 704 may include one or more core digital Application Specific Integrated Circuits (ASICs), CPUs, GPUs, microprocessors, FPGAs, combinations thereof, and the like.

The switch 704 may include a number of input ports and/or output ports 712. The Input/Output (I/O) ports 712 may include electrical ports and/or optical ports. The switch 704 may include a combination of electrical blocks and optical blocks. The electrical blocks of the switch 704 may include a number of electrical switches that are configured to route signals in an electrical domain. The optical blocks of the switch 704 may include a number of optical components that are configured to generate, detect and route signals in an optical domain. In some embodiments, a configuration of the optical block(s) and a configuration of the electrical block(s) depends (e.g., is based on) on the number of optical ports in the I/O ports 712.

Optical connectors 714 may be disposed proximate to the front panel 708. In some embodiments, connectivity between the multi-chip module assembly 702 and optical connectors 714 may be implemented using optical fibers. This connection may be made directly with an optical I/O port 712 of the switch 704 or may be made with one or more of the satellite chips 706. The connection may be made with one or more of the satellite chips 706 because the satellite chips 706 may include electro-optic converters and, possibly, a serializer/deserialized to natively support the connection. In some embodiments, the satellite chips 706 may include one or more of a DSP processor, driver, trans-impedance amplifier, laser, modulator, photodiode, serializer-deserializer, or the like.

In the context of high-throughput switches and optoelectronics, co-packaging may enable relocation of optoelectronic transceivers from the front panel 708, where they are deployed in the form of pluggable modules, to the satellite chips 706 of the networking devices 710. In some embodiments, the fiber optical I/Os from the satellite chips 706 may be disposed at the front panel 708, replacing the bulky pluggable ports. This saves area proximate to the front panel 708 which may be utilized to accommodate integration of one or more other systems.

In one embodiment, the switch 704 and satellite chips 706 are co-packaged into an optical-electrical circuit and implemented as an application specific integrated circuit (ASIC) configured to generate data signals and a plurality of symbol encoding circuits configured to convert the data signals to symbols, the symbol encoding circuits arranged as floating satellite chip 706 tiles around the central tile comprising the switch 704, and a terahertz spectrum multi-band wireless signaling interface coupling the symbol encoding circuits to the central tile.

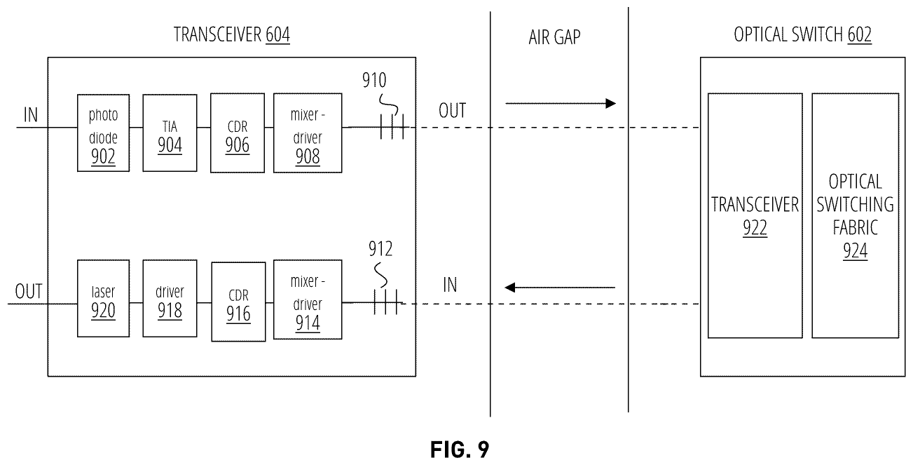

FIG. 8 depicts an exemplary co-packaging arrangement. The co-packaged arrangement includes a central tile containing the switch, floating optical tiles containing the optical transceivers, high-speed interconnects between the central switch tile and the floating optical tiles and external high-speed interconnects connecting the floating optical tiles with the rest of the network. A challenge in the switch co-packaging is how to implement effectively the high-speed interconnect between the central switch tile and the floating optical tiles.

One or more transceivers 604 are configured to receive an optical fiber (single) that is non-colinear (not along the same line) with a wireless channel between the transceiver 604 and the optical switch 602, facilitating circuit layout especially where a grid or other layout template for the optical fibers is a constraint. The co-packaged arrangement includes a central tile comprising the optical switch 602 and a plurality of floating optical tiles comprising transceivers 604. The co-packaging arrangement utilizes wireless interconnects between the central tile and the floating tiles and fiber optic interconnects coupling the floating tiles with a wider network.

FIG. 9 depicts additional aspects of a coupling between a transceiver 604 and an optical switch 602 in one embodiment. The transceiver 604 comprises components enabling a transition from an M-channel optical fiber port to the N-channel wireless interface to the optical switch 602. The transceiver 604 may be fabricated for example with CMOS components, BiCMOS components, SOI components, or any other suitable technology.

The conversion path between a fiber input port and the wireless channels may comprise a photodiode 902, a transimpedance amplifier (TIA) 904, a clock-and-data recovery circuit (CDR) 906, a mixer/driver circuit 908, and a wireless antenna 910. For signals from the optical switch 602 to the transceiver 604, the conversion path between the wireless channels and the output ports may comprise an antenna 912, a mixer/driver circuit 914, a CDR 916, a link driver circuit 918, and a laser 920. In one embodiment, an interface between the optical switch 602 and the transceivers 604 may utilize beam-forming antennae to improve port density at the periphery of the optical switch 602.

The optical switch 602 may comprise a transceiver 922 and an optical switching fabric 924. The transceiver 922 may comprise components similar to those utilized in the transceiver 604 for converting between wireless and optical signals. In some embodiments, the optical switch 602 may further comprise an optical multiplexer 1002 (FIG. 10) providing electrical to optical conversion and N: M multiplexing/de-multiplexing between the transceiver 922 and the optical switching fabric 924.

The mixer and driver 908 circuits provide an M-to-N mapping of optical channels onto the wireless bands. The clock-data recovery 906 repackages packets from the optical channels into packets on the wireless bands. The drivers 918 clock bits of the packets to the antenna 910. The wireless interface between the transceiver 604 and the optical switch 602 may comprise N mixer and driver 908 circuits, N drivers 918, and N antenna 910. The wireless interface may utilize a clock that is higher frequency (terahertz range) than the clock utilized on the optical fiber.

The antenna 912, mixer/driver circuit 914, CDR 916, and optical fiber driver circuit 918 may operate similarly in the opposite direction of data flow.

In a particular embodiment, one or more of the transceivers 604 is configured to input a single fiber that carries eight optical channels (e.g., laser lines) and maps/multiplexes these channels onto two wireless bands each carrying packets from four of the optical channels.

A computational or computing workload refers to the amount of processing that a computer system must complete within a given time period. This can involve executing various tasks, such as running applications, performing calculations, processing data, and handling user requests. Computational workloads may be assessed in terms of their intensity, complexity, and the resources they consume, such as CPU, GPU, memory, disk, and network bandwidth. For some computing workloads, the channels on an optical fiber to a particular transceiver may not be fully utilized. In other words, some of the laser lines on the fiber may not be modulated with data. In this situation, dynamic (i.e., responsive to operating conditions) remapping of optical channels to (fewer) wireless bands may be carried out to reduce power consumption at the wireless interface to the optical switch 602.

For example, a particular computing workload may fully utilize all optical channels of an optical fiber and may benefit from configuring the wireless bands to 8:1 (eight bands each carrying packets from one optical channel) or to 4:2 (four wireless bands each multiplexed with packets from two optical channels. Power savings may be achieved for a less bandwidth-intensive workload by dynamically re-configuring the wireless interface to 2:4 (two wireless bands each multiplexed with packets from four optical channels).

In a particular example, eight optical channels on an optical fiber may be fully utilized by certain algorithms in a deep learning training or inference workload. A transceiver coupled to this optical fiber may be dynamically reconfigured to map the eight optical channels onto four wireless bands to the switch, each carrying two multiplexed optical channels. The optical fiber utilization may then decrease as the system transitions to executing a different workload or a different algorithm within the deep learning workload. The transceiver may dynamically adjust to map the eight optical channels to two wireless bands each carrying four optical channels, or to two wireless bands each carrying two optical channels, depending on the extent of the falloff in optical fiber utilization.

Because the wireless bands provide collectively higher bandwidth than the optical fiber can carry, it may be unnecessary to activate all of them to keep up with the optical traffic, and the most efficient (e.g., lowest BER) links may be selected for utilization on a per-transceiver basis. The lowest BER links for each transceiver may be identified post-manufacture utilizing known calibration mechanisms, or may be determined by runtime profiling of the system.

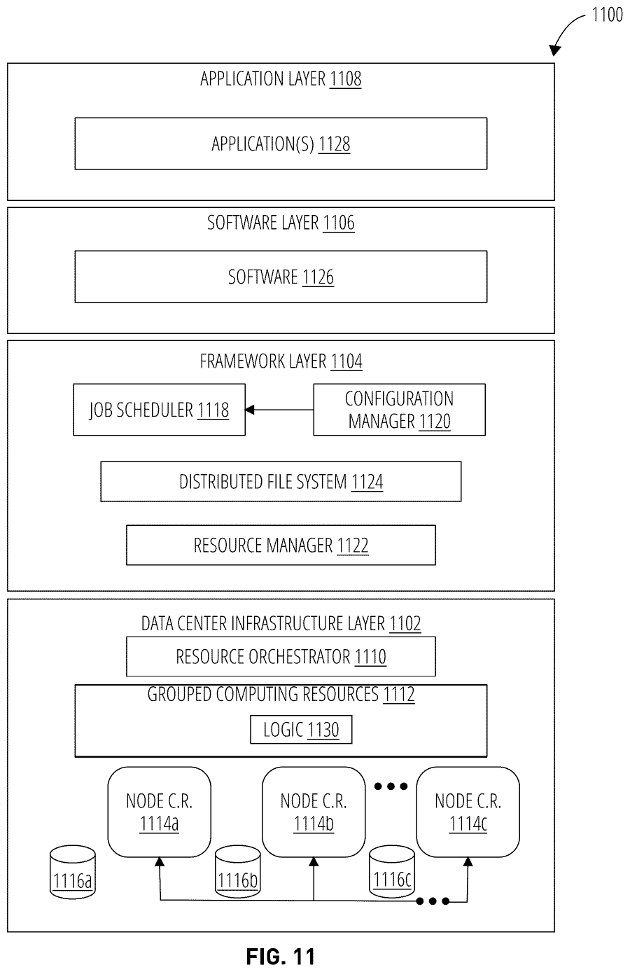

FIG. 11 depicts an exemplary data center 1100 in accordance with at least one embodiment. In at least one embodiment, data center 1100 includes, without limitation, a data center infrastructure layer 1102, a framework layer 1104, a software layer 1106, and an application layer 1108.

In at least one embodiment, as depicted in FIG. 11, data center infrastructure layer 1102 may include a resource orchestrator 1110, grouped computing resources 1112, and node computing resources (node C.R. s) 1114a, 1114b, 1114c, where “N” represents any whole, positive integer. In at least one embodiment, node computing resources may include, but are not limited to, any number of central processing units (CPUs) or other processors (including accelerators, field programmable gate arrays (FPGAs), graphics processors, etc.), memory devices 1116a, 1116b, 1116c (e.g., dynamic random-access memory, solid state or disk drives, etc.), network input/output (NW I/O) devices, network switches, virtual machines (VMs), power modules, and cooling modules, etc. In at least one embodiment, one or more node computing resources from among node computing resources 1114a, 1114b, 1114c may be a server having one or more of the above-mentioned computing resources.

In at least one embodiment, grouped computing resources 1112 may include separate groupings of node computing resources housed within one or more racks (not shown), or many racks housed in data centers at various geographical locations (also not shown). Separate groupings of node computing resources within grouped computing resources 1112 may include grouped compute network, memory, or storage resources that may be configured or allocated to support one or more workloads. In at least one embodiment, several node computing resources including CPUs or processors may be grouped within one or more racks to provide compute resources to support one or more workloads. In at least one embodiment, one or more racks may also include any number of power modules, cooling modules, and network switches (for example, co-packaged optical switches in accordance with the disclosed embodiments), in any combination.

In at least one embodiment, resource orchestrator 1110 may configure or otherwise control one or more node computing resources 1114a, 1114b, 1114c and/or grouped computing resources 1112. One or more of the node computing resources may comprise co-packaged compute tiles in accordance with the disclosed embodiments. In at least one embodiment, resource orchestrator 1110 may include a software design infrastructure (“SDI”) management entity for data center 1100. In at least one embodiment, resource orchestrator 1110 may include hardware, software, or some combination thereof.

In at least one embodiment, as depicted in FIG. 11, framework layer 1104 includes, without limitation, a job scheduler 1118, a configuration manager 1120, a resource manager 1122, and a distributed file system 1124. In at least one embodiment, framework layer 1104 may include a framework to support software 1126 of software layer 1106 and/or one or more application(s) 1128 of application layer 220. In at least one embodiment, software 1126 or application(s) 1128 may respectively include web-based service software or applications, such as those provided by Amazon Web Services, Google Cloud, and Microsoft Azure. In at least one embodiment, framework layer 1104 may be, but is not limited to, a type of free and open-source software web application framework such as Apache SPARK™ (hereinafter “Spark) that may utilize a distributed file system 1124 for large-scale data processing (e.g., “big data”). In at least one embodiment, job scheduler 1118 may include a Spark driver to facilitate scheduling of workloads supported by various layers of data center 1100. In at least one embodiment, configuration manager 1120 may be capable of configuring different layers such as software layer 1106 and framework layer 1104, including Spark and distributed file system 1124 for supporting large-scale data processing. In at least one embodiment, resource manager 1122 may be capable of managing clustered or grouped computing resources mapped to or allocated for support of distributed file system 1124 and job scheduler 1118. In at least one embodiment, clustered or grouped computing resources may include grouped computing resources 1112 at data center infrastructure layer 1102. In at least one embodiment, resource manager 1122 may coordinate with resource orchestrator 1110 to manage these mapped or allocated computing resources.

In at least one embodiment, software 1126 included in software layer 1106 may include software used by at least portions of node computing resources 1114a, 1114b, 1114c, grouped computing resources 1112, and/or distributed file system 1124 of framework layer 1104. One or more types of software may include, but are not limited to, Internet web page search software, e-mail virus scan software, database software, and streaming video content software.

In at least one embodiment, application(s) 1128 included in application layer 1108 may include one or more types of applications used by at least portions of node computing resources 1114a, 1114b, 1114c, grouped computing resources 1112, and/or distributed file system 1124 of framework layer 1104. In at least one or more types of applications may include, without limitation, Compute Unified Device Architecture (CUDA) applications, 5G network applications, artificial intelligence applications, data center applications, and/or variations thereof. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1120, resource manager 1122, and resource orchestrator 1110 may implement any number and type of self-modifying actions based on any amount and type of data acquired in any technically feasible fashion. In at least one embodiment, self-modifying actions may relieve a data center operator of data center 1100 from making possibly bad configuration decisions and possibly avoiding underutilized and/or poorly performing portions of a data center.

In at least one embodiment, data center 1100 may comprise tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1100. In at least one embodiment, trained machine learning models corresponding to one or more neural networks may be used to infer or predict information using resources described above with respect to data center 1100 by using weight parameters calculated through one or more training techniques described herein.

In at least one embodiment, data center 1100 may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

The grouped computing resources 1112 may be configured with logic 1130 to implement the application(s) 1128. For example, the logic 1130 may comprise inference and/or training logic to perform deep learning inferencing and/or training operations associated with one or more embodiments. In at least one embodiment, logic 1130 may configure the data center 1100 for inferencing or predicting operations based, at least in part, on weight parameters calculated using neural network training operations, neural network functions and/or architectures, or neural network use cases described herein.

### LISTING OF DRAWING ELEMENTS

100 computing environment
102 server
104 CPU
106 switch
108 GPU
110 DPU
112 NIC
114 DDR memory
116 NVMe device
118 network
120 memory
122 pool
202 network interface card
204 input
206 output
208 communication channel
210 communication channel
400 computer system
402 CPU
404 communications bus
406 main memory
408 network interface
410 input devices
412 parallel processing system
414 display devices
416 parallel processing unit
418 memory
420 interconnect
422 switch
500 computing system
502 network
504 network
506 switch
508 NIC/DPU
510 switch
512 NIC/DPU
514 processing device
516 CPU
518 GPU
520 GPU
522 interconnect
524 interconnect
526 NIC/DPU
528 processing device
530 CPU
532 GPU
534 GPU
536 interconnect
538 interconnect
540 NIC/DPU
542 NIC/DPU
544 interconnect
602 optical switch
604 transceiver
702 multi-chip module assembly
704 switch
706 satellite chip
708 front panel
710 networking device
712 I/O port
714 optical connectors
716 controller
902 photodiode
904 transimpedance amplifier
906 clock-data recovery
908 mixer and driver
910 antenna
912 antenna
914 mixer and driver
916 clock-data recovery
918 driver
920 laser
922 transceiver
924 optical switching fabric
1002 optical multiplexer
1100 data center
1102 data center infrastructure layer
1104 framework layer
1106 software layer
1108 application layer
1110 resource orchestrator
1112 grouped computing resources
1114a node computing resource
1114b node computing resource
1114c node computing resource
1116a memory device
1116b memory device
1116c memory device
1118 job scheduler
1120 configuration manager
1122 resource manager
1124 distributed file system
1126 software
1128 application(s)
1130 logic

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S. C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A circuit package comprising:
an optical switch comprising a wireless interface; and
a plurality of floating transceivers positioned along a periphery of the optical switch configured to map a plurality of optical channels from an optical fiber into multi-band wireless signals in a terahertz spectrum.

2. The circuit package of claim 1, wherein one or more of the floating transceivers is configured to convert a number M>1 of the optical channels into N>1 wireless bands to the optical switch.

3. The circuit package of claim 2, wherein M≠N.

4. The circuit package of claim 3, wherein one or more of the floating transceivers is configured to multiplex L>1 of the optical channels onto each of one or more of the wireless bands.

5. The circuit package of claim 2, wherein one or more of the floating transceivers are configured with differing values of N.

6. The circuit package of claim 2, wherein N is dynamically configurable for different computational workloads.

7. The circuit package of claim 1, wherein at least one floating transceiver is configured to receive a single optical fiber that is non-colinear with a wireless channel between the transceiver and the optical switch.

8. The circuit package of claim 1, wherein the optical switch and floating transceivers are comprised by a data processing unit (DPU).

9. The circuit package of claim 1, wherein the optical switch and floating transceivers are comprised by a network interface card (NIC).

10. A computer network device comprising:
a plurality of optical fiber inputs;
an optical switch formed on a central die, the optical switch comprising a wireless interface; and
a plurality of floating transceivers each formed on a die disposed on a periphery of the central die, each of the floating transceivers configured to map a plurality of optical channels from a corresponding one or more of the optical fibers into terahertz spectrum multi-band wireless signals on the wireless interface.

11. The computer network device of claim 10, wherein:
the wireless interface comprises a plurality of wireless channels that are not colinear with the corresponding one or more of the optical fibers.

12. The computer network device of claim 10, wherein one or more of the floating transceivers is configured to convert eight of the optical channels into four wireless bands to the optical switch.

13. The computer network device of claim 10, wherein one or more of the floating transceivers is configured to convert eight of the optical channels into two wireless bands to the optical switch.

14. The computer network device of claim 10, wherein one or more of the floating transceivers is configured to multiplex two or more of the optical channels onto each of one or more of the wireless bands.

15. The computer network device of claim 12, wherein one or more of the floating transceivers are dynamically configurable to generate different numbers of the wireless bands to the optical switch.

16. The computer network device of claim 12, wherein numbers of the wireless bands is dynamically configurable in response to different computational workloads.

17. The computer network device of claim 10, wherein the optical switch and the floating transceivers are comprised by a data processing unit (DPU).

18. The computer network device of claim 10, wherein the optical switch and floating transceivers are comprised by a network interface card (NIC).

19. A data center comprising:
a plurality of central processing units;
a plurality of graphics processing units;
an co-packaging arrangement of circuit die, comprising:
a plurality of optical fiber inputs from one or more of the central processing units and the graphics processing units;
an optical switch formed on a central die, the optical switch comprising a wireless interface; and
a plurality of transceivers each formed on a die disposed on a periphery of the central die, each of the transceivers configured to map a plurality of optical channels from a corresponding one or more of the optical fibers into terahertz spectrum multi-band wireless signals on the wireless interface.

20. The data center of claim 19, wherein one or more of the transceivers is configurable to convert a number M>1 of the optical channels into N>1 wireless bands to the optical switch, wherein M≠N.

21. A network switch comprising:
an optical fiber interface;
a central tile comprising a switch; and
a plurality of floating transceivers each formed on a die disposed between the optical fiber interface and the central tile, each of the floating transceivers configured to map a plurality of optical channels from the optical fiber interface into terahertz spectrum multi-band wireless signals to the central tile.

22. A co-packaged optical-electrical circuit comprising:
an application specific integrated circuit (ASIC) configured to generate data signals, the ASIC comprising:
a central tile comprising a switch;
a plurality of symbol encoding circuits configured to convert the data signals to symbols, the symbol encoding circuits arranged as floating tiles around the central tile; and
a terahertz spectrum multi-band wireless signaling interface coupling the symbol encoding circuits to the central tile.

23. A terahertz spectrum wireless link comprising:
a first end coupled to a floating transceiver tile; and
a second end coupled to a central tile comprising a switch.
